(19) United States
(12) Patent Application Publication
(10) Pub. No.: US 2016/0128388 A1
(43) Pub. Date: May 12, 2016

(54) ELECTRONIC CIGARETTE

(71) Applicant: KIMREE HI-TECH INC., Tortola (VG)

(72) Inventor: QIUMING LIU, Huizhou City, Guangdong Province (CN)

(21) Appl. No.: 14/411,869

(22) PCT Filed: May 20, 2013
(86) PCT No.: PCT/CN2013/075935

§ 371 Date: Jan. 25, 2016

(51) Int. Cl. A24F 47/00; H05B 3/00

(52) U.S. Cl. CPC A24F 47/008; H05B 3/00

(57) ABSTRACT

Disclosed is an electronic cigarette, comprising a tube sleeve and an atomizer assembly which is provided in the tube sleeve and is used for producing smoke, wherein the atomizer assembly comprises an oil storage space which is mainly composed of a liquid storage part; the atomizer assembly is provided with a support mechanism which prevents the oil storage space from deforming excessively when the oil storage space is pressed. By means of the support mechanism, the electronic cigarette can achieve the technical effects of no overflow of cigarette oil after the electronic cigarette is pressed, a robust structure and stable and reliable quality.

### FIELD OF THE INVENTION

The present invention relates to an electronic cigarette.

### BACKGROUND OF THE INVENTION

Electronic cigarette is a simulation cigarette, using heating wire to heat and atomize substance containing fragrance to produce smoke for users smoking. A ventilation component of an atomization chamber of a conventional electronic cigarette is a soft ventilation tube 200 which always uses glass fiber tube, cotton fiber tube or flexible hose and etc. Referring to FIG. 1, when a tube sleeve wall 100 at a position of an atomizer assembly is pressed, which will cause a space volume V300 between the soft ventilation tube 200 and the tube sleeve wall 100 which is mainly formed by oil storage cotton reduced. Especially when the compression degree is serious, the soft ventilation tube 200 is deformed excessively to flatten, at this time the space volume V300 is almost zero, then oil overflows from an inner hole of the soft ventilation tube 200 through an air outlet of a mouthpiece cover, which not only affects appearance of the product, but also affects performance thereof such as makes users absorbing oil.

Therefore, the conventional electronic cigarette has defects such as a structure is not strong and oil overflows when being pressed seriously, affecting the product appearance and performance.

### SUMMARY OF THE INVENTION

Therefore, the present invention provides an electronic cigarette with a robust structure, stable and reliable quality.

In order to achieve the above-mentioned objective, the present invention provides an electronic cigarette, comprising an atomizer assembly which is used for producing smoke. The atomizer assembly comprises an oil storage space which is mainly composed of a liquid storage part. The atomizer assembly is provided with a support mechanism to prevent the oil storage space from deforming excessively when the oil storage space is pressed. By the means of the support mechanism being provided in the oil storage space, the electronic cigarette can effectively prevent problem of oil overflowing caused by the oil storage space deforming excessively when being pressed. That is to say, because of the supporting from the support mechanism, even the atomizer assembly is pressed seriously, the deforming of the oil storage space will not reach critical state of oil overflowing.

Furthermore, the atomizer assembly further includes a soft ventilation tube which is provided coaxially with the liquid storage part in the oil storage space. The support mechanism is a support tube which is coaxial with the soft ventilation tube and tensioningly provided in an inner wall of the soft ventilation tube. Specifically, the support mechanism not only plays a supporting role, but also has a ventilation function. The support mechanism is made of materials such as ceramic, glass, metal or high temperature resistant hard plastic to play a supporting role, and may also adapt to the environment of high temperature in the atomizer assembly. Preferably, the supporting mechanism is one or more sections.

Furthermore, a cross section of the support tube is round or polygonal. Preferably, the polygonal is triangular, quadrilateral, pentagonal and etc. Preferably, the cross section of the support tube may also be oval. The polygonal is regular polygonal or non-regular polygonal.

Furthermore, an outer surface of the support tube along a circumferential direction is provided with screw threads. Therefore, by using the screw threads facilitates the rotating installation of the support tube.

Furthermore, one end of the support tube is provided with a guide groove and an inner wall of the soft ventilation tube is convex provided with a bulge matching the guide groove, therefore facilitates the accurate installation of the support tube.

Furthermore, the atomizer assembly further includes a soft ventilation tube which is provided coaxially with the liquid storage part in the oil storage space. The support mechanism is a first support part which is coaxial with the soft ventilation tube and tensioningly provided in an inner wall of the soft ventilation tube.

Furthermore, a cross section of the first support part is “T”, “Y”, “+” or “*” shaped. The structure of the first support part not only achieves good supporting function, but also ensures that the soft ventilation tube has enough space for ventilation.

Furthermore, the atomizer assembly further includes a soft ventilation tube which is provided coaxially with the liquid storage part in the oil storage space. The support mechanism is a first support body which is coaxial with the soft ventilation tube and tensioningly provided in an inner wall of the soft ventilation tube.

Furthermore, the first support body includes a first cylinder body and a first rod body which are coaxial and in turn nested and provided inward. Preferably, the first cylinder body and the first rod body are an integrally formed structure. Therefore, by using the first cylinder body and the first rod body, comparing to a single cylinder body or rod body, not only makes the electronic cigarette more compression resistance, making the structure of the electronic cigarette stable and quality stable and reliable, but also ensures that the first cylinder body has enough space for ventilation.

Furthermore, a cross section of the first cylinder body is round or polygonal. Preferably, the polygonal is triangular, quadrilateral, pentagon and etc. Preferably, the cross section of the first cylinder body also can be oval. The polygonal is regular polygonal or non-regular polygonal.

Furthermore, a cross section of the first rod body is “T”, “Y”, “+” or “*” shaped. The structure of the first rod body not only achieves good supporting function, but also ensures that the soft ventilation tube has enough space for ventilation.

Furthermore, the support mechanism is a hard ventilation tube which is coaxially with the liquid storage part and tensioningly provided in the oil storage space. Preferably, the hard ventilation tube uses high temperature resistant hard tube such as ceramic tube, glass tube, metal tube, high temperature resistant plastic pipe and etc.

Furthermore, a cross section of the hard ventilation tube is round or polygonal. Preferably, the polygonal is triangular, quadrilateral, pentagon and etc. Preferably, the cross section of the hard ventilation tube also can be oval. The polygon is regular polygonal or non-regular polygonal.

Furthermore, an outer surface of the hard ventilation tube along the circumferential direction is provided with screw threads. Therefore, by using the screw threads facilitates the rotating installation of the hard ventilation tube.

Furthermore, one end of the hard ventilation tube is provided with a guide groove and the inner wall of the oil storage space is convex provided with a bulge matching the guide groove, therefore facilitating the accurate installation of the hard ventilation tube.

Furthermore, the support mechanism is a second support part which is coaxial with the liquid storage part and tensioningly provided inside the oil storage space.

Furthermore, a cross section of the second support part is “T”, “Y”, “+” or “*” shaped. The structure of the second support part not only achieves good supporting function, but also ensures that the oil storage space has enough space for ventilation.

Furthermore, the support mechanism is a second support body which is coaxial with the liquid storage part and tensioningly provided in the oil storage space.

Furthermore, the second support body includes a second cylinder body and a second rod body which are coaxial and in turn nesting disposed inward. Preferably, the second cylinder body and the second rod body are an integrally formed structure. Therefore, by using the second cylinder body and the second rod body, comparing to a single cylinder body or rod body, not only makes the electronic cigarette more compression resist, making the structure of the electronic cigarette stable and quality stable and reliable, but also ensures that the second cylinder body has enough space for ventilation.

Furthermore, a cross section of the second cylinder body is round or polygonal. Preferably, the polygonal is triangular, quadrilateral, pentagon and etc. Preferably, a cross section of the second cylinder body also can be oval. The polygonal is regular polygonal or non-regular polygonal.

Furthermore, a cross section of the second rod body is “T”, “Y”, “+” or “*” shaped. The structure of the second rod body not only achieves good supporting function, but also ensures that the second cylinder body has enough space for ventilation.

Beneficial effects of the electronic cigarette of the embodiment of the present invention are: by means of the atomizer assembly provided with the support mechanism to prevent the oil storage space deforming excessively when the oil storage space being pressed, therefore the electronic cigarette achieves the technical effects of no overflow of cigarette oil when the electronic cigarette is pressed, and has a robust structure and stable and reliable quality.

### BRIEF DESCRIPTION OF THE DRAWINGS

FIG. 1 is a schematic view of a deforming process of a conventional electronic cigarette when pressed.

FIG. 2 is a schematic view of a deforming process of an electronic cigarette when pressed according to an embodiment of the present invention.

FIG. 3 is a sectional view of the electronic cigarette of the embodiment of the present invention.

FIG. 4 is a schematic view of a support mechanism of a first embodiment of the present invention.

FIG. 5 is a schematic view of a support mechanism of a second embodiment of the present invention.

FIG. 6 is a schematic view of a support mechanism of a third embodiment of the present invention.

FIG. 7 is a schematic view of a support mechanism of a fourth embodiment of the present invention.

FIG. 8 is a schematic view of a support mechanism of a fifth embodiment of the present invention.

FIG. 9 is a schematic view of a support mechanism of a sixth embodiment of the present invention.

FIG. 10 is a schematic view of a support mechanism of a seventh embodiment of the present invention.

FIG. 11 is a schematic view of a support mechanism of an eighth embodiment of the present invention.

### DETAILED DESCRIPTION OF THE INVENTION

It is needed to state that embodiments and all element limitations in all embodiments may be combined in the case of no conflicts. The present invention will be described in detail in the following combining figures and embodiments.

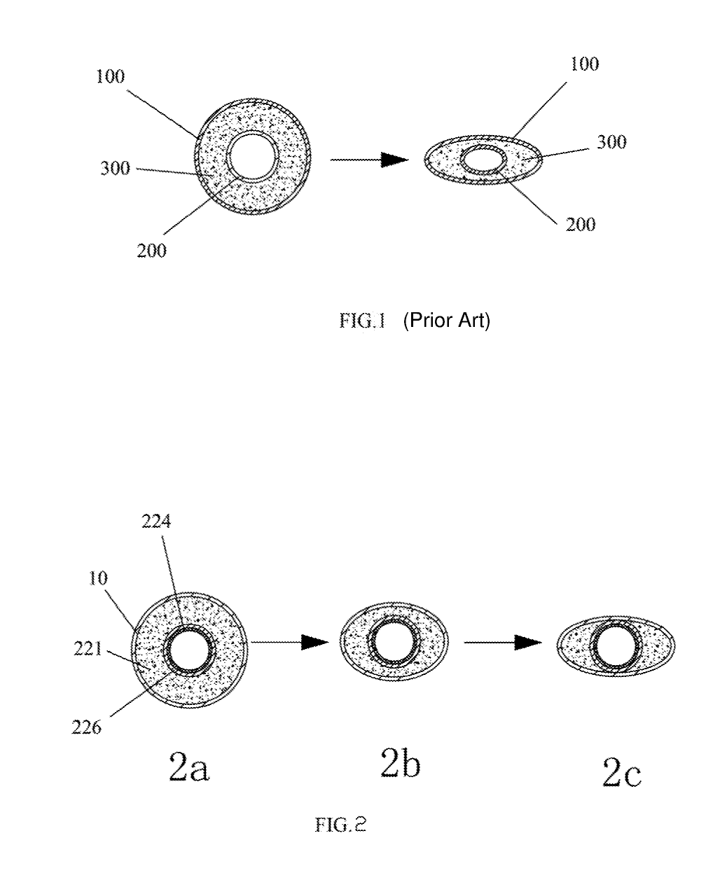

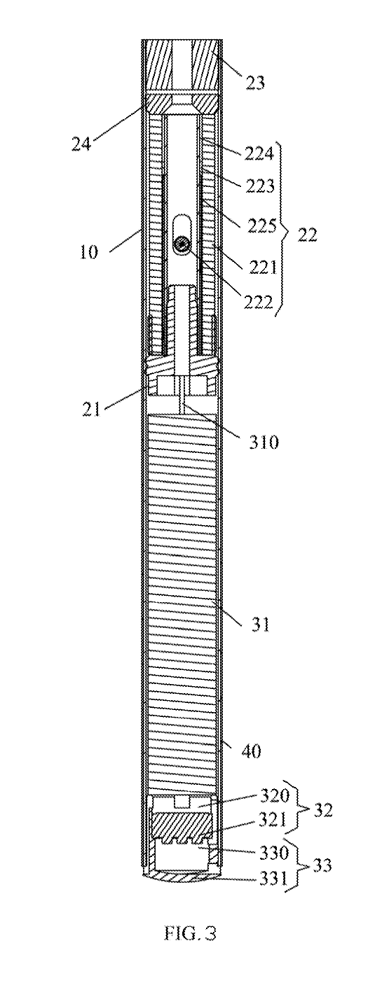

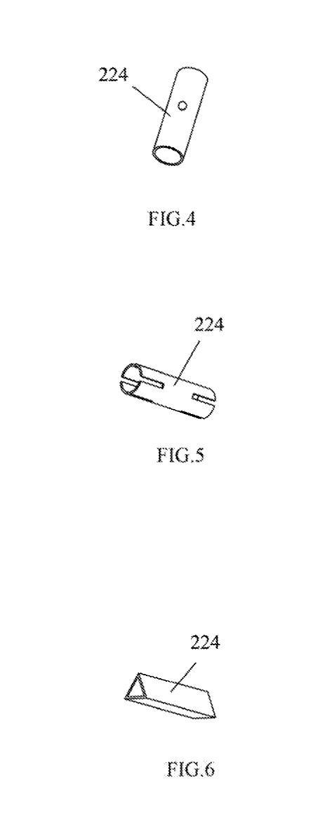

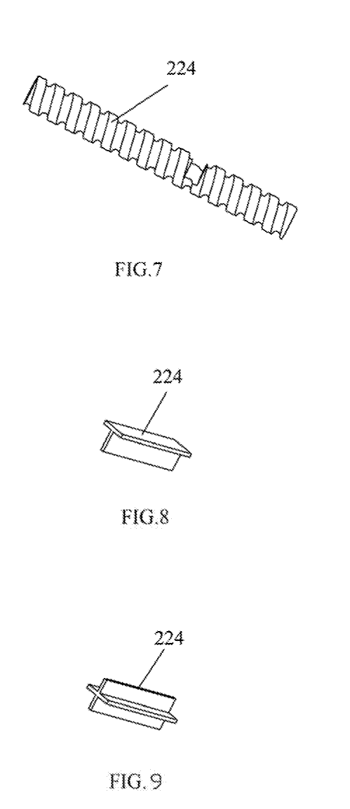

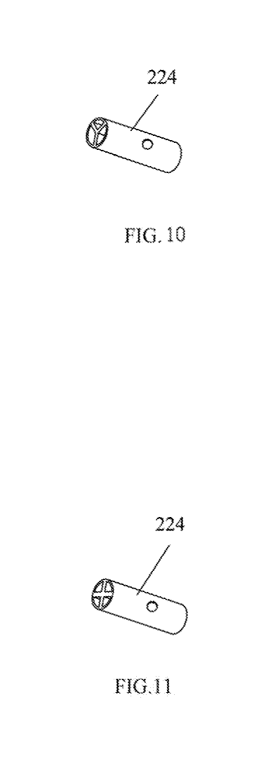

Referring to FIG. 2 and FIG. 3, the present invention provides an electronic cigarette, an atomizer assembly 22 of the electronic cigarette is provided with a support mechanism 224 to prevent an oil storage space from deforming excessively when the oil storage space is pressed. Even when the electronic cigarette is serious pressed, there is no oil overflowing, with robust structure, stable and reliable quality. In FIG. 2a: when the electronic cigarette is not pressed, a tube sleeve 10 and the support mechanism 224 are not deformed, which will not cause oil overflowing. In FIG. 2b: when the electronic cigarette is slightly pressed, the tube sleeve 10 is slightly deformed and the support mechanism 224 is not deformed, which will also not cause oil overflowing. In FIG. 2c: when the electronic cigarette is seriously pressed, the tube sleeve 10 is more deformed than that of 2b, an inner wall of the tube sleeve 10 is almost tightly stick to an outer wall of the support mechanism 224, and the structure of the support mechanism 224 is firm, so there is no deformation or slight deformation, and no oil is overflowing.

The electronic cigarette of the present invention includes the tube sleeve 10 which is cylindrical and made of elastic materials, an atomizer seat 21 provided in the tube sleeve 10, the atomizer assembly 22 for producing smoke and a mouthpiece cover 23 provided at one end of the tube sleeve 10. In the embodiment, the electronic cigarette may be a disposable electronic cigarette, or is a repeatedly use electronic cigarette. Herein, the disposable electronic cigarette is described as an example. The tube sleeve 10 is made of soft materials such as silicone rubber, plastic or paper. Preferably, an outer surface of the tube sleeve 10 further provided with a sticker 40 to imitate real cigarette and improve comfort.

In the embodiment, the atomizer assembly 22 includes the oil storage space which is mainly composed of a liquid storage part 221, and a heating assembly 222. The liquid storage part 221 is sleeved around the support mechanism 224, and the support mechanism 224 is used to prevent the oil storage space from deforming excessively when the oil storage space pressed. The heating assembly 222 includes a liquid guide wire and a heating wire which is winding on an outer surface of the liquid guide wire. The heating assembly 222 inserts through the support mechanism 224. In order to properly supply oil for the liquid guide wire, the support mechanism 224 is further sleeved with an oil guide cotton tube 225. The oil guide cotton tube 225 and the support mechanism 224 are sleeved with a fixed sleeve 223 to compress and fix the heating assembly 222. In the embodiment, the liquid storage part 221 is made of oil storage cotton, and the oil guide cotton tube 225 and the fixed sleeve 223 are all made of non-woven fabric, therefore can properly supply oil for the liquid guide wire. An inner of the mouthpiece cover 23 is provided with a sealing ring 24. The atomizer assembly 22 is sleeved and fixed on the atomizer seat 21.

In the sleeve tube 10 further provides a power 31. One end of the power 31 provides a switch module 32 and a light cap assembly 33. The power 31 is connected with the heating wire by a conducting wire 310. The switch module 32 includes an abutment 320 and an airflow sensor 321 which is fixed on the abutment 320. The light cap assembly 33 includes a light cap 330 and an LED light 331 which is red and provided inside in the light cap 330 and used for simulating a burning cigarette and indicating status.

As an embodiment, the atomizer assembly 22 further includes a soft ventilation tube 226 (as FIG. 2 shown) which is provided coaxially with the liquid storage part 221 in the oil storage space. The support mechanism 224 is a support tube which is coaxial with the soft ventilation tube 226 and tensioningly provided in an inner wall of the soft ventilation tube 225. Preferably, a cross section of the support mechanism is round or polygonal. Preferably, an outer surface of the support tube along a circumferential direction is provided with screw threads. Preferably, one end of the support tube is provided with a guide groove and an inner wall of the soft ventilation tube is convex provided with a bulge matching the guide groove.

As an embodiment, the atomizer assembly 22 further includes a soft ventilation tube 226 which is provided coaxially with the liquid storage part 221 in the oil storage space. The support mechanism 224 is a first support part which is coaxial with the soft ventilation tube 226 and tensioningly provided in the inner wall of soft ventilation tube 226. Preferably, a cross section of the first support part is “T”, “Y”, “+” or “*” shaped.

As an embodiment, the atomizer assembly 22 further includes a soft ventilation tube 226 which is provided coaxially with the liquid storage part 221 in the oil storage space. The support mechanism 224 is a first support body which is coaxial with the soft ventilation tube 226 and tensioningly provided in an inner wall of soft ventilation tube 226. Preferably, the first support body includes a first cylinder body and a first rod body. The first cylinder body and the first rod body are coaxial with the soft ventilation tube 226 and in turn nestingly disposed inward. Preferably, a cross section of the first cylinder body is round or polygonal. Preferably, the cross section of the first rod body is “T”, “Y”, “+” or “*” shaped.

As an embodiment, referring to FIG. 3 and FIG. 4, the support mechanism 224 is a hard ventilation tube which is coaxially with the liquid storage part 221 and tensioningly provided in the oil storage space. Preferably, a cross section of the hard ventilation tube is round or polygonal. Preferably, an outer surface of the hard ventilation tube along a circumferential direction is provided with screw threads. Preferably, one end of the hard ventilation tube is provided with a guide groove and an inner wall of the oil storage space is convex provided with a bulge matching the guide groove.

As an embodiment, the support mechanism 224 is a second support part which is coaxial with the liquid storage part 221 and tensioningly provided inside the oil storage space. Preferably, a cross section of the second support part is “T”, “Y”, “+” or “*” shaped.

As an embodiment, the support mechanism 224 is a second support body which is coaxial with the liquid storage part 221 and tensioningly provided inside the oil storage space. Preferably, the second support body includes a second cylinder body and a second rod body. The second cylinder and the second rod body are coaxial with the liquid storage part 221, and in turn nestingly disposed inward. Preferably, a cross section of the second cylinder body is round or polygonal. Preferably, a cross section of the second rod body is “T”, “Y”, “+” or “*” shaped.

In summary, according to the conception of the present invention, the atomizer assembly 22 of the electronic cigarette is divided into two categories: one is including the soft ventilation tube 226, and the soft ventilation tube 226 is tensioningly provided with the support mechanism 224 therein; another is not including the soft ventilation tube 226, and the oil storage space is directly tensioningly provided in the support mechanism 224. The support mechanism 224 includes three types, one is cylindrical, one is a support part, and another one is a combination structure of the former two. The support mechanism 224 may also be divided as one section assembly or multi-section assembly, and may also be divided as a shape with hole or groove and a shape without hole or groove. By means of providing the support mechanism 224 in the atomizer assembly 22 to prevent the oil storage space deformation excessively when the oil storage space is pressed, the electronic cigarette of the embodiment of the present invention achieves the technical effects of no overflow of cigarette oil after the electronic cigarette is pressed, and has a robust structure and stable and reliable quality.

Embodiments of the present invention is shown and described in the above-mentioned. Various improvement and modifications can be made to the embodiments by those skilled in the art without departing from the true spirit and scope of the disclosure. The scope of the present invention is defined by the appended claims and equivalents thereof.

1. An electronic cigarette, comprising:
an atomizer assembly used for producing smoke, the atomizer assembly including an oil storage space which is mainly composed of a liquid storage part;
wherein the atomizer assembly is provided with a support mechanism to prevent the oil storage space from deforming excessively when the oil storage space is pressed.

2. According to the electronic cigarette in claim 1, wherein the atomizer assembly further includes a soft ventilation tube which is provided coaxially with the liquid storage part in the oil storage space, and the support mechanism is a support tube which is coaxial with the soft ventilation tube and tensioningly provided in an inner wall of the soft ventilation tube.

3. According to the electronic cigarette in claim 2, wherein a cross section of the support tube is round or polygonal.

4. According to the electronic cigarette in claim 2, wherein an outer surface of the support tube along a circumferential direction is provided with screw threads.

5. According to the electronic cigarette in claim 2, wherein one end of the support tube is provided with a guide groove and the inner wall of the soft ventilation tube is convex provided with a bulge matching the guide groove.

6. According to the electronic cigarette in claim 1, wherein the atomizer assembly further includes a soft ventilation tube which is provided coaxially with the liquid storage part in the oil storage space, and the support mechanism is a first support part which is coaxial with the soft ventilation tube and tensioningly provided in an inner wall of the soft ventilation tube.

7. According to the electronic cigarette in claim 6, wherein a cross section of the first support part is “T”, “Y”, “+” or “*” shaped.

8. According to the electronic cigarette in claim 1, wherein the atomizer assembly further includes a soft ventilation tube which is provided coaxially with the liquid storage part in the oil storage space, and the support mechanism is a first support body which is coaxial with the soft ventilation tube and tensioningly provided in an inner wall of the soft ventilation tube.

9. According to the electronic cigarette in claim 8, wherein the first support body includes a first cylinder body and a first rod body which are coaxial and in turn nestingly disposed inward.

10. According to the electronic cigarette in claim 9, wherein a cross section of the first cylinder body is round or polygonal.

11. According to the electronic cigarette in claim 9, wherein a cross section of the first rod body is “T”, “Y”, “+” or “*” shaped.

12. According to the electronic cigarette in claim 1, wherein the support mechanism is a hard ventilation tube which is coaxially with the liquid storage part and tensioningly provided in the oil storage space.

13. According to the electronic cigarette in claim 12, wherein a cross section of the hard ventilation tube is round or polygonal.

14. According to the electronic cigarette in claim 13, wherein an outer surface of the hard ventilation tube along a circumferential direction is provided with screw threads.

15. According to the electronic cigarette in claim 13, wherein one end of the hard ventilation tube is provided with a guide groove and an inner wall of the oil storage space is convex provided with a bulge matching the guide groove.

16. According to the electronic cigarette in claim 1, wherein the support mechanism is a second support part which is coaxial with the liquid storage part and tensioningly provided in the oil storage space.

17. According to the electronic cigarette in claim 16, wherein a cross section of the second support part is “T”, “Y”, “+” or “*” shaped.

18. According to the electronic cigarette in claim 1, wherein the support mechanism is a second support body which is coaxial with the liquid storage part and tensioningly provided in the oil storage space.

19. According to the electronic cigarette in claim 18, wherein the second support body includes a second cylinder body and a second rod body which are coaxial and in turn nestingly disposed inward.

20. According to the electronic cigarette in claim 19, wherein a cross section of the second cylinder body is round or polygonal, and a cross section of the second rod body is “T”, “Y”, “+” or “*” shaped.

21. (canceled)
